(19) United States
(12) Patent Application Publication
(10) Pub. No.: US 2017/0137297 A1
(43) Pub. Date: May 18, 2017

(54) A Method For Producing An Activated Nesquehonite

(71) Applicant: Gulf Organisation for Research and Development, Doha (QA)

(72) Inventors: Mohammed S. Imbabi, Aberdeen, Aberdeenshire (GB); Frederik P. Glasser, Aberdeen, Aberdeenshire (GB); Jose-Luis Galvez-Martos, Aberdeen, Aberdeenshire (GB); Guillaume Jauffret, Aberdeen, Aberdeenshire (GB); Jennie Morrison, Aberdeen, Aberdeenshire (GB); Esam Elsarrag, Doha (QA); Yousefl Al-Horr, Doha (QA)

(21) Appl. No.: 15/320,543

(22) PCT Filed: Jun. 25, 2015
(86) PCT No.: PCT/GB2015/051846

§ 371 Date: Dec. 20, 2016

(30) Foreign Application Priority Data
Jun. 25, 2014 (GB) 1411248.6

(51) Int. Cl. C01F 5/24; C04B 22/10; C04B 28/02

(52) U.S. Cl. CPC C01F 5/24; C04B 28/02; C04B 22/10; C01P 2004/03; C01P 2004/10

(57) ABSTRACT

A method for producing an activated nesquehonite includes activating one or more nesquehonites by heating. The one or more nesquehonites may be formed by the reaction of carbon dioxide with aqueous magnesium ions at elevated pH, and may include barringtonite, nesquehonite, dypingite, hydromagnesite, and/or artinite and/or lansfordite. The activated nesquehonite may be useful in a building material, and have advantageous cementitious properties.

The present invention relates to a method of producing an activated nesquehonite.

Barringtonite, nesquehonite, and lansfordite are the naturally occurring di-, tri- and pentahydrates of magnesium carbonate, MgCO₃.2H₂O, MgCO₃.3H₂O and MgCO₃.5H₂O respectively. They can be prepared by mixing a solution of magnesium and carbonate ions from the reaction of carbon dioxide with aqueous magnesium ions at elevated pH.

For brevity, herein these and related magnesium carbonates (including magnesium (hydroxy) carbonate hydrates) will be referred to collectively as “nesquehonites”, abbreviated to “NQs”. “Nesquehonites” and “NQs” thus refer collectively to all members of this family of materials, including the nesquehonite-lansfordite family, MgCO₃.nH₂O, the hydromagnesite-dypingite family, Mg₅(CO₃)₄(OH)₂.nH₂O, and the artinite family, Mg₂(CO₃)(OH)₂.3H₂O, and are not limited to any specific member or sub-family of this family unless explicitly stated, “a/the nesquehonite” and “NQ” similarly referring in general terms to any member of this family of materials, unless it is clear that nesquehonite itself (magnesium carbonate trihydrate, MgCO₃.3H₂O) is specifically being referred to. This family of materials may also be referred to in the art as MHCHs (magnesium (hydroxy) carbonate hydrates).

According to the present invention there is provided a method for producing an activated nesquehonite, which method comprises activating one or more nesquehonites by heating.

The one or more nesquehonites (NQs) activated in the method of the present invention may be selected from the nesquehonite-lansfordite family MgCO₃.nH₂O, including barringtonite, nesquehonite, and/or lansfordite, MgCO₃.2H₂O, MgCO₃.3H₂O and MgCO₃.5H₂O respectively, including mixtures thereof, preferably nesquehonite itself. The one or more NQs may be selected from the hydromagnesite-dypingite family, Mg₅(CO₃)₄(OH)₂.nH₂O, and/or the artinite family, Mg₂(CO₃)(OH)₂.3H₂O, for example dypingite hydromagnesite, and/or artinite, 4MgCO₃.Mg(OH)₂.5H₂O, 4MgCO₃.Mg(OH)₂.4H₂O and/or Mg₂CO₃(OH)₂.3H₂O respectively. The one or more NQs may include any mixture of the above.

When NQs are activated by heating, water is lost in stages. This water loss may be accompanied by a change in the characteristic structure of the particular NQ in question. Thus, the structure after activation may be different to the structure before activation, the structure after activation possibly no longer being characteristic of the structure of the unactivated NQ. Accordingly, the term “activated NQ(s)” refers to the particular NQ which has been activated. For example, “activated NQ” refers to the material resulting from activation of NQ (which, for example, results in an X-ray amorphous phase which is not characteristic of unactivated NQ).

The activated NQs produced by the method of the present invention may have a number of useful applications, including building materials, for use in the construction of buildings and infrastructure, and in particular may show improved cementitious properties for use as mouldable cementitious materials on rehydration.

The method of the present invention preferably comprises activating the one or more NQs by heating to a temperature of from 40 to 300° C., or from 75 to 400° C., more preferably from 50 to 100° C., from 120 to 200° C., or from 150to 250° C., for example approximately 200° C.

The method of the present invention preferably further comprises the steps of forming the NQs by the reaction of carbon dioxide with aqueous magnesium ions at elevated pH. Preferably, the carbon dioxide is reacted with alkali to form carbonate and/or bicarbonate anions at elevated pH, and the carbonate and/or bicarbonate anions are subsequently reacted with aqueous magnesium ions to form the NQs. An advantage of this preferred method of the present invention is that it provides a method of capture and utilization/sequestering of carbon dioxide.

In this connection, the combustion of hydrocarbons produces carbon dioxide at unacceptable levels, as evidenced by the rising carbon dioxide content of the atmosphere and its impacts on climate.

Many efforts have been made to prevent or reduce the accumulation of carbon dioxide, but these are either too expensive or are of uncertain effectiveness in the long term, or both.

Carbon capture and storage in the Earth's crust or underground are examples; physical separation of carbon dioxide from nitrogen, which comprises 80% of the normal atmosphere, is expensive, and geological storage of carbon dioxide, which remains partly in liquid form, is of uncertain effectiveness and safety. Biological conversion to biomass, via photosynthesis, remains a possibility, but may not yield useful products, achieve permanent sequestration, or be economic.

Present processes centre around carbon dioxide capture and storage. Presently available processes require (i) a gas treatment step, stripping carbon dioxide from the much more abundant nitrogen and water vapour in outlet gases from, for example, a coal-fired power plant and (ii) liquefaction of the carbon dioxide followed by its deposition in underground storage, perhaps in disused oil or gas horizons. This however requires considerable investment in plant and process equipment and, of course, the success of permanent storage depends on a number of factors which are not readily assessed, including the integrity of the reservoir and its seals, as well as the absence of disruptive events.

A preferred method of the present invention thus provides a method for utilizing carbon dioxide which comprises reacting the carbon dioxide with aqueous magnesium ions at elevated pH to form one or more NQs.

A preferred method of the present invention comprises reacting the carbon dioxide with alkali to form carbonate and/or bicarbonate anions at elevated pH, and subsequently reacting the carbonate and/or bicarbonate anions with aqueous magnesium cations to form the one or more NQs. This two-stage reaction has advantages over a one-stage reaction (i.e. reacting the carbon dioxide with alkali and aqueous magnesium cations together) in that the amount of alkali to be used can be optimised, since an excess of alkali might increase alkalinity to a level restricting or preventing disposal, and the carbon dioxide capture and precipitation steps can be differentiated and separately controlled, resulting in a more efficient use of alkali and temperature monitoring and control.

In the preferred method, the carbon dioxide, or carbonate and/or bicarbonate containing aqueous solution is reacted with the aqueous magnesium ions at elevated pH, for example 8 to 12, preferably 9 to 12, for example 10 to 11 measured at 25° C. The pH of the aqueous solution may be elevated either before or during reaction of the aqueous magnesium ions with the carbon dioxide, but as noted above is preferably elevated before reaction of the aqueous magnesium ions with the carbon dioxide. The elevation of pH (i) increases the solubility of carbon dioxide in water, (ii) enhances the saturation rate of brine with respect to carbon dioxide—hydroxide acts as a catalyst—and (iii) precipitates magnesium, whose solubility reduces at high pH, with concomitant precipitation of the one or more NQs.

The carbon dioxide is preferably reacted with alkali at an elevated concentration of alkali, for example 1 to 3 equivalent moles of alkali per litre, preferably 1.5 to 2. A mixture of carbonates and bicarbonates forms according to the following reactions:

CO₂(g)+2OH⁻(aq)→CO₃²⁻(aq)+H₂O(l) [1]

CO₂(g)+CO₃²⁻(aq)+H₂O(l)→2HCO₃⁻(aq) [2]

According to reactions [1] and [2], the equivalent moles of alkali per mole of captured carbon dioxide would be between 1 and 2, preferably 1.5 to 2.

The carbonate and/or bicarbonate containing aqueous solution resulting from the reaction of the carbon dioxide with alkali preferably reacts with the magnesium ions precipitating the one or more NQs at a temperature of 10 to 80° C., preferably 20 to 70° C., more preferably 20 to 60° C.

The pH of the aqueous solution in the preferred method of the present invention for producing NQ may be raised using any suitable alkaline material, such as hydroxides. For example, sodium hydroxide may be used for this purpose. Ammonia may also be used because it can in principle be recovered and recycled.

A preferred alkaline material for use in elevating the pH of the aqueous solution is Cement Kiln Dust (CKD). CKD is a waste material which is normally collected and disposed of in landfill. CKD will typically be used as a supplementary source of alkali along with other alkaline materials, such as sodium hydroxide.

The operation of a cement plant requires that the effluent gas is treated by electrostatic precipitation to remove mineral dusts prior to discharge. The dust is enriched in alkali, mainly in the form of sulfate and in free lime, CaO. Upon contact with water, sulfate is partly precipitated as calcium sulfate hydrate while the alkali is effectively and spontaneously converted to sodium and potassium hydroxide. Thus, the reaction of CKD with water provides hydroxide ions.

CKD mainly comprises particulate matter from the kilns of the cement plant and mineralogically typically consists of free CaO (lime) as well as calcite, calcium sulphate and calcium silicates.

A condensate may be added to the CKD from the kiln gas phase. This adds alkali chloride(s), for example potassium chloride, KCl, and other volatiles to the dust. In this way, the dust may contain two classes of potentially soluble salts: (i) condensate salts such as KCl and (ii) free lime together with calcium silicate. The former class dissolves rapidly in water giving a high pH solution but with limited potential to buffer a high pH, while the latter have a high pH as well as better buffering capacity but with the potential disadvantage that they leave behind a solid residue.

Other alkaline waste materials may be used in the method of the present invention, for example waste aluminium cleaning caustic soda solution, and pulp and paper mill wastes.

Any suitable source of aqueous magnesium ions may be used in the preferred method of the present invention for producing NQs. For example, seawater contains approximately 1 to 2 g/L of magnesium. However, a preferred source of aqueous magnesium ions is reject water from a desalination plant, on account of its enrichment in magnesium, approximately 2 to 5 g/L. The reduction in water volume resulting from the use of desalination plant effluent can provide economic benefits over using a less enriched magnesium ion source, such as seawater. Other potential sources of magnesium ions include formation waters, commercially used in magnesium metal production.

A further advantage in the use of reject water from desalination plants in the preferred method of the present invention is that the water which is returned to the sea after having been used in the method will contain fewer magnesium salts and be less alkaline than before, and is thus environmentally less harmful.

The method of the present invention preferably reacts carbon dioxide with aqueous magnesium ions at elevated pH to form NQs, and more preferably reacts carbon dioxide with alkali at elevated pH to form carbonates and/or bicarbonates, which are subsequently reacted with aqueous magnesium ions, precipitating NQs, preferably at a temperature of 10 to 80° C., more preferably 20 to 70° C. The magnesium ions may for example be present in brine or reject water from a desalination plant. Examples of salts which may be formed include salts of the nesquehonite-lansfordite family, MgCO₃.nH₂O, the hydromagnesite-dypingite family, Mg₅(CO₃)₄(OH)₂.nH₂O, and the artinite family, Mg₂(CO₃)(OH)₂.3H₂O. A table of different phases which may be formed from these reactions is given below in Table 1:

TABLE 1

| | | Mass (%) | | |
|---|---|---|---|---|
| Mineral name | Chemical formula | | CO₂ | H₂O |
| Lansfordite | MgCO₃•5H₂O | 23.1 | 25.2 | 51.7 |
| (LF) | | | | |
| Nesquehonite | MgCO₃•3H₂O | 29.1 | 31.8 | 39.1 |
| (NQ) | | | | |
| Artinite | Mg₂CO₃(OH)₂•3H₂O | 41.0 | 22.4 | 36.6 |
| (AN) | | | | |
| Dypingite | 4MgCO₃•Mg(OH)₂•5H₂O | 41.5 | 36.2 | 22.3 |
| (DG) | | | | |
| Hydromagnesite | 4MgCO₃•Mg(OH)₂•4H₂O | 43.1 | 37.6 | 19.3 |
| (HM) | | | | |
| Barringtonite | MgCO₃•2H₂O | 33.5 | 36.5 | 30.0 |
| (BA) | | | | |

Of these different phases, NQ, DG, HM and BA maximise the percentage by weight of carbon dioxide which may be absorbed per unit weight of magnesium. In this connection, the weight of carbon dioxide which may be captured per unit weight of these phases in terms of kg of carbon dioxide per kg of magnesium is 1.81 for NQ and BA, and 1.45 for HM.

The favoured formation of a particular phase can be achieved by selecting one or more of the reaction conditions, such as temperature and reaction time, carbon dioxide partial pressure and/or alkali concentration. For example, at room temperature NQ itself appears to slowly convert to DG, and then over time to HM, in aqueous conditions over a period of months or years.

According to the present invention there is also provided a material comprising one or more nequehonites produced by a method of the present invention.

The materials of the present invention may have a number of different useful applications, for example as building materials. Herein “building material” means any product formed from NQs for use in the construction of buildings and infrastructure, whether internally or externally, load bearing or non-load bearing. For example, the material of the present invention may be a cement, for example to produce a mortar or render, a board product, concrete, or a construction block. Unmodified NQs have an advantage over conventional cements in that they are lightweight. The material of the present invention may alternatively be a sound insulator and/or a thermal insulator, or a fire retardant (NQs are incombustible). The material of the present invention may be suitable for use in a pharmaceutical product. NQs are also 100% recyclable.

The material of the present invention can be used as a mouldable cementitious material on rehydration. For example, a moulded product may be formed from one or more activated NQs, either alone or with another material, by forming the one or more activated NQs into a paste, filling a mould with the paste and curing in a wet atmosphere, for example over a period of up to 36 hours, preferably up to hours, at room temperature, before de-moulding. On removal from the mould the cured product maintains its coherence. The choice of activation conditions, in particular temperature, is important in the activation of cementitious behaviour. Other methods of using the activated NQs may include spraying over an object. Other materials or admixtures applied to the activated NQs may also be used to modify the hydrated material.

The present invention will now be described in detail by way of an Example, with reference to the accompanying drawings in which:

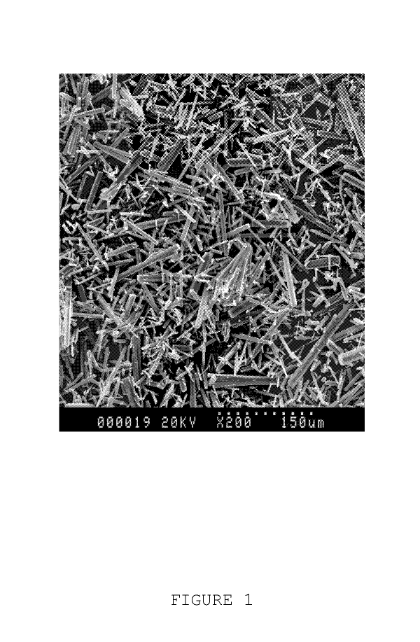

FIG. 1 is a micrograph showing needles of Nesquehonite (NQ) MgCO₃.3H₂O obtained from the reaction of a magnesium-containing brine and a carbon dioxide-rich solution at 25° C.; and

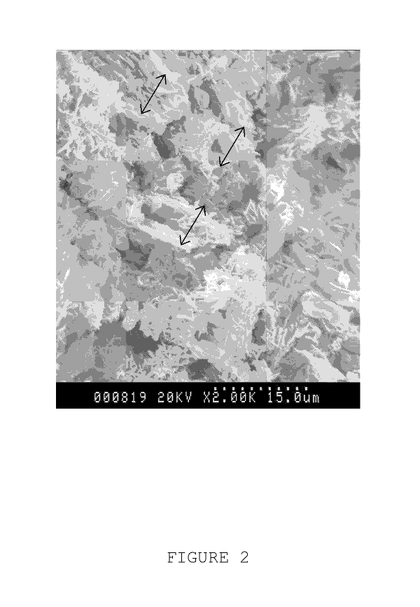

FIG. 2 is a micrograph showing the microstructure of a fragment of a cube prepared with thermally activated Nesquehonite (NQ) MgCO₃.3H₂O.

### EXAMPLE

### Synthesis Study

Experiments were performed to study the effects of varying the temperature and reaction time on the phase of product formed from a preferred method of the present invention, including the yields of magnesium and consequently carbon dioxide in the product, the results of which are set out below in Table 2.

Thus, 100 ml of a 1M MgCl₂ solution was added to 1L of a 0.1M Na₂CO₃ solution brought to the target temperature. After filtration, the solid was dried over silica gel, ground, and scanned by XRD and SEM.

The yield of the reaction for Mg was calculated. The mass of Mg in the filtrate was calculated from Atomic Absorption Spectroscopy (AAS) measurements: the lower the Mg concentration in the filtrate, the higher the yield and so the higher the amount of Mg being precipitated. The uncertainty of the yield values is +/−5% due to uncertainties in amounts recovered and in analyses. For example, variations in the total volume as well as the amount of water incorporated in the solid products have been neglected: for 0.1 mol of NQ precipitated, the volume of water incorporated is the order of 5 mL, whereas for 0.02 mol of HM precipitated, the volume of water incorporated is the order of 2 mL (results for an initial total volume of approximately 1.1L).

The yield of the reaction for CO₂ can be calculated from the Mg yield (N.B. “DG★” is short-hand notation for a dypingite-like phase, i.e. a phase similar to hydromagnesite but with more than 4 moles of crystallisation water per formula unit, DG being the specific case where there are 5 moles of crystallisation water).

TABLE 2

| | | Main phase in | Mg yield | CO₂ yield |
|---|---|---|---|---|
| T (° C.) | t (h) | product | (mass %) | (mass %) |
| 25 | 1 | NQ | 59 | 59 |
| | 2 | NQ | 82 | 82 |
| | 4 | NQ | 91 | 91 |
| | 24 | NQ | 86 | 86 |
| 35 | 1 | NQ | 68 | 68 |
| | 2 | NQ | 77 | 77 |
| | 4 | NQ + DG* | 77 | 76-77 |
| | 24 | DG* | 73 | 58 |
| 45 | 1 | NQ + DG* | 77 | 76-77 |
| | 2 | NQ + DG* | 82 | 81-82 |
| | 4 | NQ + DG* | 82 | 75-78 |
| | 24 | DG* | 86 | 69 |
| 55 | 1 | NQ + DG* | 77 | 76-77 |
| | 2 | DG* | 73 | 58 |
| | 4 | DG* | 82 | 66 |
| | 24 | HM + DG* | 82 | 66 |
| 65 | 1 | HM + DG | 86 | 69 |
| | 2 | HM + DG | 86 | 69 |
| | 4 | HM + DG* | 86 | 69 |
| | 24 | HM | 95 | 76 |

Thus, to summarise the data in Table 2, at the lowest temperature of 25° C. NQ was the predominant phase for all reaction times from 1 to 24 hours, and remained the dominant phase at 35° C. for shorter reaction times of 1 to 2 hours. From 4 to 24 hour reaction times at 35° C. through increasing temperature to 55° C. the predominant phase contained DG★, either with NQ, with HM (at 24 hours reaction time at 55° C.) or alone, and at 65° C. the predominant phase contained HM, with DG at shorter reaction times of from 1 to 2 hours, with DG★ at 4 hour reaction time, and alone at 24 hour reaction time.

FIG. 1 shows a scanning electron micrograph of NQ crystals formed at 25° C. and subsequently air dried. The magnification scale is X200, and the total length of the line formed by connecting dots is 150 microns (0.15 mm).

The crystals grow with characteristic needle to long prismatic shapes with clean surfaces and often with terminating pinacoids. The terminations show that the crystals are solid. Individual crystals do not generally cohere or join, with the result that dry powders and powder compacts have strong preferred orientation and a high proportion of interstitial space.

FIG. 2 shows a hydrated self-cemented cube formed from the NQ shown in FIG. 1, once activated. The image is of a fracture surface and the magnification relative to FIG. 1 is increased by approximately ten-fold.

To make the cube, NQ (FIG. 1) was activated by heating to 100° C. in air. Crystalline reflections characteristic of NQ disappear during heating but morphological relicts of the original crystals persist even after rehydration as hollow needles (arrowed in FIG. 2). On rewetting and curing at ˜20° C., NQ is regenerated and cemented by formation of intermediate products; the latter are fine-grained and, at this magnification, have a poor morphology. Several types of pore space are thus created in the cemented product, which has low bulk density, in this example ca 700 kg/m³. The presence of small air voids comprising a significant proportion of the whole volume contributes to the low thermal conductivity.

It will be understood that the embodiments illustrated above describe the invention only for the purposes of illustration. In practice the invention may be applied in different embodiments and applications.

1. A method for producing an activated nesquehonite, which method comprises activating one or more nesquehonites by heating.

2. A method according to claim 1 wherein the one or more nesquehonites are activated by heating to a temperature of from 40 to 300° C., or from 75 to 400° C.

3. A method according to claim 2 wherein the one or more nesquehonites are activated by heating to a temperature of from 50 to 100° C., from 120 to 200° C., or from 150 to 250° C.

4. A method according to claim 1 which further comprises the steps of forming the one or more nesquehonites by the reaction of carbon dioxide with aqueous magnesium ions at elevated pH.

5. A method according to claim 4 wherein the carbon dioxide is reacted with alkali to form carbonate and/or bicarbonate anions at elevated pH, and the carbonate and/or bicarbonate anions are subsequently reacted with aqueous magnesium ions to form the one or more nesquehonites.

6. A method according to claim 4 wherein the carbon dioxide, or carbonate and/or bicarbonate containing aqueous solution, is reacted with the aqueous magnesium ions at a pH of 8 to 12, preferably 9 to 12, for example 10 to 11, measured at 25° C.

7. A method according to claim 5 wherein the carbon dioxide is reacted with the alkali at 1 to 3 equivalent moles of alkali per litre.

8. A method according to claim 5 wherein the equivalent moles of alkali per mole of captured carbon dioxide is between 1 and 2.

9. A method according to claim 5 wherein the carbonate and/or bicarbonate containing aqueous solution resulting from the reaction of the carbon dioxide with alkali reacts with the magnesium ions precipitating the one or more nesquehonites at a temperature of 10 to 80° C., preferably 20 to 70° C., more preferably 20 to 60° C.

10. A method according to claim 4 wherein the alkaline material for use in elevating the pH of the aqueous solution comprises Cement Kiln Dust (CKD).

11. A method according to claim 10 wherein a condensate is added to the CKD from the kiln gas phase.

12. A method according to claim 4 wherein the source of aqueous magnesium ions comprises reject water from a desalination plant, or formation waters.

13. A method according to claim 4 wherein the magnesium ions are present in the aqueous solution in an amount of 2 to 5 g/L.

14. A method according to claim 4 for capture and utilization/sequestering of carbon dioxide.

15. A method according to claim 1 wherein the one or more nesquehonites is selected from the nesquehonite-lansfordite family MgCO₃.nH₂O, the hydromagnesite-dypingite family, Mg₅(CO₃)₄(OH)₂.nH₂O, and/or the artinite family, Mg₂(CO₃)(OH)₂.3H₂O, and any mixture thereof

16. A method according to claim 15 wherein the one or more nesquehonites is selected from barringtonite, nesquehonite, and/or lansfordite, MgCO₃.2H₂O, MgCO₃.3H₂O and MgCO₃.5H₂O respectively, dypingite, hydromagnesite, and/or artinite, 4MgCO₃.Mg(OH)₂.5H₂O, 4MgCO₃.Mg(OH)₂.4H₂O and/or Mg₂CO₃(OH)₂.3H₂O respectively, and any mixture thereof.

17. A method according to claim 15 for producing nesquehonite.

18. A material comprising one or more nesquehonites produced by a method according to claim 1.

19. A material according to claim 18 which is a cement, mortar or render, a board product, concrete, a construction block, a sound insulator and/or a thermal insulator, a fire retardant, and/or is suitable for use in a pharmaceutical product.

20. A material according to claim 18 which comprises a mouldable cementitious material comprising one or more rehydrated nesquehonites.

21. A material according to claim 20 which comprises a moulded product formed from one or more activated nesquehonites, either alone or with another material, by forming the one or more activated nesquehonites into a paste, filling a mould with the paste and curing in a wet atmosphere.

22. A material according to claim 21 wherein the paste is cured over a period of up to 36 hours, preferably up to 24 hours, at room temperature before de-moulding.
